(19) United States
(12) Patent Application Publication
(10) Pub. No.: US 2026/0234818 A1
(43) Pub. Date: Aug. 13, 2026

(54) MIXED CATALYST LAYERS FOR ELECTROLYTIC CELLS

(71) Applicant: GM Global Technology Operations LLC, Detroit, MI (US)

(72) Inventors: Swaminatha P. Kumaraguru, Rochester Hills, MI (US); Bahareh Alsadat Tavakoli Mehrabadi, Rochester Hills, MI (US); Nagappan Ramaswamy, Rochester Hills, MI (US)

(21) Appl. No.: 19/051,500

(22) Filed: Feb. 12, 2025

(51) Int. Cl. C25B 11/097; C25B 1/04; C25B 9/19; C25B 11/037

(52) U.S. Cl. CPC C25B 11/097; C25B 1/04; C25B 9/19; C25B 11/037

(57) ABSTRACT

Systems, methods, and devices for enhancing catalyst layer performance in electrolytic cells are described. The enhanced catalyst layers include a catalyst mixture having catalyst particles and corrosion-resistant, conductive nanoparticles to optimize interfacial contact and reduce in-plane discontinuities even at low areal loadings of catalyst particles. For example, a catalyst layer includes a matrix with a homogenous mixture of catalyst particles and corrosion-resistant, conductive nanoparticles. The catalyst particles are configured to promote water electrolysis. The catalyst particles include iridium and have a high surface area. The corrosion-resistant, conductive nanoparticles are configured to resist oxidation, to reduce packing discontinuities of the catalyst particles, and to provide an electrically conductive bridge between the catalyst particles. The matrix is configured to support the catalyst particles and the corrosion-resistant, conductive nanoparticles.

### INTRODUCTION

The disclosure relates to the field of electrolysis and, more specifically, to systems and methods for enhancing catalyst layer performance.

In electrolysis systems, electrocatalysts are often used to expedite half-cell reactions. Iridium is used as an active component in electrocatalysts for high-efficiency and robust oxygen evolution reaction. However, there is a low abundance of iridium. Accordingly, low areal loadings of iridium are desirable.

Iridium oxide-based catalysts are the primary choice of catalysts to promote the oxygen evolution reaction in polymer electrolyte membrane water electrolysis cells. Iridium oxide has a relatively high density (e.g., 11.66 grams per cubic centimeter). Accordingly, at low areal loadings, iridium oxide forms compact electrode structures.

Based on Tafel kinetics, the voltage loss from use of less iridium oxide areal loading in a membrane electrode assembly or voltage loss for a given membrane-electrode assembly due to iridium dissolution and agglomeration during operation are theoretically very low. But, in actual tests, significant voltage losses are observed. For example, an iridium oxide areal loading of 0.1 milligrams per square centimeter or less will produce a catalyst layer with a thickness of less than 1 micron. Moreover, the catalyst layer will have a relatively irregular interface surface to contact an adjacent porous transport layer.

### SUMMARY

The observed voltage loss is attributed to reduced catalyst layer thickness and increased contact and in-plane electronic resistance. The irregular interface surface reduces contact between the catalyst layer and an adjacent porous transport layer. Moreover, low areal loading in the thin layer produces in-plane discontinuity that causes in-plane contact resistance, which increases cell voltage losses. This in-plane contact resistance may be present at the beginning-of-life due to non-uniform dispersion of catalyst particles within thinner films and/or may develop during operation due to iridium dissolution.

Systems, methods, and devices in accordance with the present disclosure provide a catalyst mixture that includes catalyst particles and corrosion-resistant, conductive nanoparticles.

Beneficially, use of the catalyst mixture as described herein optimizes interfacial contact and reduces in-plane discontinuities even at low areal loadings of catalyst particles both at beginning-of-life and throughout operation.

The catalyst layer is formed from the catalyst mixture including catalyst particles and corrosion-resistant, conductive nanoparticles within a binder. The corrosion-resistant, conductive nanoparticles are configured to increase continuity of the catalyst layer and optimize interfacial contact of the catalyst layer. The corrosion-resistant, conductive nanoparticles may be sized to bridge packing discontinuities between catalyst particles.

Further, the interfacial contact of the catalyst layer may be optimized by optimizing a thickness of the catalyst layer to produce a uniform interface surface. The optimized thickness may be determined based on the size of the catalyst particles and the corrosion-resistant, conductive nanoparticles. For example, in some aspects, corrosion resistant conductive nanoparticles are used to reduce contact-resistance-related durability losses by producing a mixed-oxide catalyst layer with an optimized thickness at low iridium-loading values. For example, at an iridium-oxide areal loading of 0.1 milligrams per square centimeter, the mixed-oxide catalyst layer may have a thickness of at least 2 μm, at least 4 μm, or even greater thicknesses.

According to aspects of the present disclosure, a catalyst layer includes a matrix with a homogenous mixture of catalyst particles and corrosion-resistant, conductive nanoparticles. The catalyst particles are configured to promote water electrolysis. The catalyst particles include iridium and have a high surface area. The corrosion-resistant, conductive nanoparticles are configured to resist oxidation, to reduce packing discontinuities of the catalyst particles, and to provide an electrically conductive bridge between the catalyst particles. The matrix is configured to support the catalyst particles and the corrosion-resistant, conductive nanoparticles.

According to further aspects of the present disclosure, the catalyst particles are selected from the group consisting of iridium oxide particles or iridium-oxide containing particles.

According to further aspects of the present disclosure, the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

According to further aspects of the present disclosure, the corrosion-resistant, conductive nanoparticles are selected from the group consisting of platinum-coated titanium dioxide (Pt/TiO₂), gold-coated titanium dioxide (Au/TiO₂), and iridium-coated titanium dioxide (Ir/TiO₂).

According to further aspects of the present disclosure, the corrosion-resistant, conductive nanoparticles are platinum-coated particles with a platinum content of 40% by weight to 80% by weight on a basis of the weight of the corrosion-resistant, conductive nanoparticle.

According to further aspects of the present disclosure, the corrosion-resistant, conductive nanoparticles have an average size from 20 nanometers to 300 nanometers.

According to further aspects of the present disclosure, the ratio of corrosion-resistant, conductive nanoparticles to catalyst particles is from 0.5:1 to 8:1 on a basis of weight.

According to further aspects of the present disclosure, the catalyst layer has a thickness greater than 4 microns and an iridium oxide packing density of less than 0.25 milligrams per cubic centimeter.

According to further aspects of the present disclosure, the catalyst layer has a thickness greater than 2 microns and an iridium oxide packing density of less than 0.5 milligrams per cubic centimeter.

According to aspects of the present disclosure, a membrane-electrode assembly includes an anode, a cathode, and a membrane disposed between the anode and the cathode. The anode has a catalyst layer including a matrix with a homogenous mixture of catalyst particles and corrosion-resistant, conductive nanoparticles. The catalyst particles are configured to promote water electrolysis. The catalyst particles include iridium and have a high surface area. The corrosion-resistant, conductive nanoparticles are configured to resist oxidation, to reduce packing discontinuities of the catalyst particles, and to provide an electrically conductive bridge between the catalyst particles. The matrix is configured to support the catalyst particles and the corrosion-resistant, conductive nanoparticles.

According to further aspects of the present disclosure, the catalyst particles are selected from the group consisting of iridium oxide particles or iridium-oxide containing particles.

According to further aspects of the present disclosure, the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

According to further aspects of the present disclosure, the corrosion-resistant, conductive nanoparticles are platinum-coated particles with a platinum content of 50% by weight to 80% by weight on a basis of the weight of the corrosion-resistant, conductive nanoparticle.

According to further aspects of the present disclosure, the corrosion-resistant, conductive nanoparticles have an average size from 20 nanometers to 300 nanometers.

According to further aspects of the present disclosure, the ratio of corrosion-resistant, conductive nanoparticles to catalyst particles is from 0.5:1 to 8:1 on a basis of weight.

According to further aspects of the present disclosure, the catalyst layer has a thickness greater than 4 microns and an iridium oxide packing density of less than 0.25 milligrams per cubic centimeter.

According to aspects of the present disclosure, an electrolytic cell includes a membrane-electrode assembly and a pair of polar plates abutting opposite sides of the membrane-electrode assembly. The membrane-electrode assembly includes an anode, a cathode, and a membrane disposed between the anode and the cathode. The anode has a catalyst layer including a matrix with a homogenous mixture of catalyst particles and corrosion-resistant, conductive nanoparticles. The catalyst particles are configured to promote water electrolysis. The catalyst particles include iridium and have a high surface area. The corrosion-resistant, conductive nanoparticles are configured to resist oxidation, to reduce packing discontinuities of the catalyst particles, and to provide an electrically conductive bridge between the catalyst particles. The matrix is configured to support the catalyst particles and the corrosion-resistant, conductive nanoparticles. Each of the pair of polar plates is electrically coupled to a respective one of the anode and the cathode and are fluidically coupled to the respective one of the anode and the cathode.

According to further aspects of the present disclosure, the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

According to further aspects of the present disclosure, the corrosion-resistant, conductive nanoparticles are platinum-coated particles with a platinum content of 40% by weight to 80% by weight on a basis of the weight of the corrosion-resistant, conductive nanoparticle.

According to further aspects of the present disclosure, the wherein the ratio of corrosion-resistant, conductive nanoparticles to catalyst particles is from 0.5:1 to 8:1 on a basis of weight.

The above features and advantages and other features and advantages of the present disclosure are readily apparent from the following detailed description of the best modes for carrying out the disclosure when taken in connection with the accompanying drawings.

### BRIEF DESCRIPTION

The drawings are illustrative and not intended to limit the subject matter defined by the claims. Exemplary aspects are discussed in the following detailed description and shown in the accompanying drawings in which:

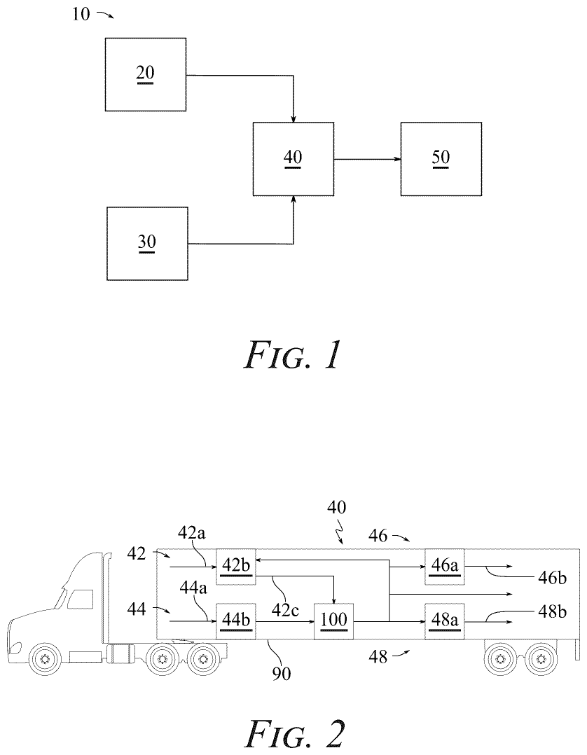

FIG. 1 illustrates an electrolysis environment, according to aspects of the present disclosure;

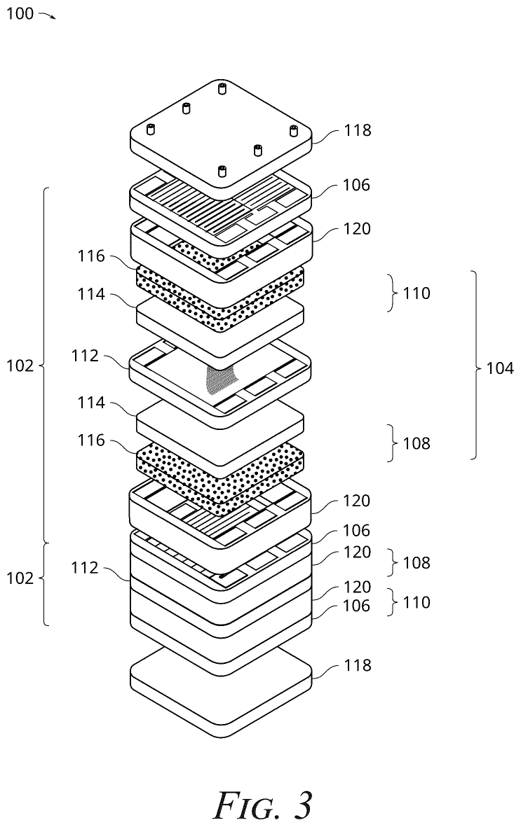

FIG. 2 illustrates an electrolysis system within the electrolysis environment of FIG. 1;

FIG. 3 illustrates a partially exploded view of an electrolytic-cell stack within the electrolysis system of FIG. 2;

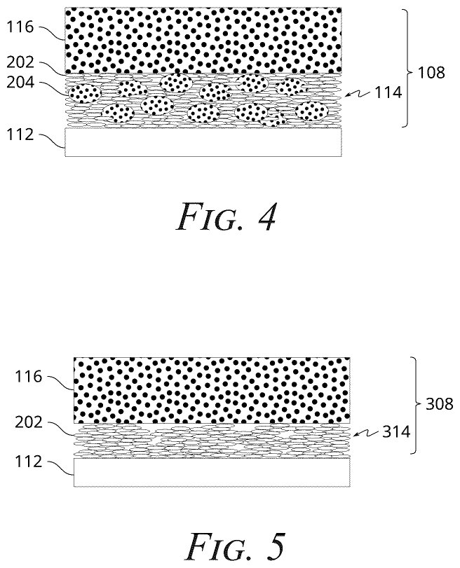

FIG. 4 illustrates a lateral end view of an anode within the electrolytic-cell stack of FIG. 3; and

FIG. 5 illustrates a lateral end view of a comparative anode formed without corrosion-resistant, conductive nanoparticles.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

FIG. 1 illustrates an electrolysis environment 10, according to aspects of the present disclosure. The electrolysis environment 10 includes a power supply 20, a fluid supply 30, an electrolysis system 40, and one or more product outlets 50.

The power supply 20 is configured to supply electric power to the electrolysis system 40. The power supply 20 may supply electric power that is produced off-site and/or on-site. The off-site power supply may be, for example, an electrical grid coupled to the electrolysis system 40. The on-site power supply may be, for example, renewable energy sources including solar panels, wind energy harvesters, hydrogen batteries (e.g., hydrogen fuel cells and hydrogen storage), combinations thereof, and the like.

The fluid supply 30 is configured to supply a reactant to the electrolysis system 40. The reactant is configured to be decomposed by the electrolysis system 40 into its component parts. The reactant may be, for example water such that the electrolysis system 40 outputs diatomic hydrogen and diatomic oxygen. The fluid supply 30 may further include one or more additives or mechanisms configured to promote decomposition of the reactant within the electrolysis system 40.

The electrolysis system 40, described in more detail with reference to FIG. 2, below, is configured to receive fluid from the fluid supply 30 and decompose the reactant using power received from the power supply 20. The products of the decomposition are then supplied from the electrolysis system 40 to the product outlets 50.

The product outlets 50 are configured to store and/or transfer products produced by the electrolysis system 40 to other portions of the electrolysis environment 10. The products may be stored for use on-site, stored for batch transfer off-site, transferred off-site via infrastructure, combinations thereof, and the like. In some aspects, the on-site use includes, for example, energy production using via fuel cells, heat generation via combustion, a combination thereof, and the like. In some aspects, the batch transfers are made by supplying products to container vehicles, product-consuming vehicles (e.g., hydrogen-powered vehicles), a combination thereof, and the like. In some aspects, the electrolysis environment 10 includes at least one product infrastructure, and one or more of the products are supplied to the respective product infrastructure.

FIG. 2 illustrates an example electrolysis system 40 for use in the electrolysis environment 10. In the illustrated embodiment, the electrolysis system 40 is within a container 90. Beneficially, the container 90 allows for the electrolysis system 40 to be transported between locations and deployed for either temporary or indefinite use at the deployment location. The electrolysis system 40 includes a fluid input stream 42, a power input 44, an electrolytic-cell stack 100, and one or more output streams 46, 48

The fluid input stream 42 is configured to store and/or convey the fluid to the electrolytic-cell stack. The fluid input stream 42 may include a fluid receiving element 42a, a fluid storage 42b, and a stack inlet 42c.

The fluid receiving element 42a is configured to be coupled to the fluid supply 30 and receive the reactant therefrom. The fluid may be received continuously or in batches.

The fluid storage 42b is configured to store and/or buffer the reactant input into the electrolytic-cell stack 100. The fluid storage 42b may be, for example, a fluid-storage vessel and may store the reactant at a predetermined pressure. The predetermined pressure may be, for example, atmospheric pressure, higher than atmospheric pressure, or lower than atmospheric pressure. In some aspects, the fluid storage 42b is not included within the electrolysis system 40.

The stack inlet 42c is configured to convey the reactant from an upstream portion of the fluid input stream 42 to the electrolytic-cell stack. The stack inlet 42c may include one or more mechanisms configured to condition the products for use in the electrolytic-cell stack. For example, the stack inlet 42c may include a plurality of valves and/or pumps configured to maintain and/or regulate pressure and flow rate of the reactant into the electrolytic-cell stack 100.

The power input 44 is configured to store and/or convey power for use by the electrolytic-cell stack. The power input 44 may include a power receiving element 44a and power storage 44b. The power receiving element 44a is configured to be coupled to the power supply 20 and receive power therefrom. The power storage 44b is configured to store and/or buffer the power that is input to the electrolytic-cell stack 100. The power storage 44b may be, for example, a battery or a capacitor.

The electrolytic-cell stack 100, described in further detail with reference to FIG. 3, below, is configured to decompose the reactant using power received from the power input 44 into a plurality of products.

Each output stream 46, 48 is configured to convey a respective one or more of the products from the electrolytic-cell stack to the product outlets 50 of the electrolysis environment 10. The output streams 46, 48 may include a hydrogen output stream 46 and an oxygen output stream 48.

The hydrogen output stream 46 is configured to convey hydrogen generated by the electrolytic-cell stack to a respective one or more of the product outlets 50. The hydrogen output stream 46 may include, for example, a hydrogen storage 46a and a hydrogen output element 46b.

The hydrogen storage 46a is configured to store and/or buffer the hydrogen generated by the electrolytic-cell stack 100. The hydrogen storage 46a may be, for example, a hydrogen-storage vessel configured to store hydrogen in a predetermined form. The predetermined form may be, for example, under pressure or converted to a hydrogen complex or hydrogen-containing molecule. The hydrogen complex or hydrogen-containing molecule may be configured to store and release hydrogen based on a change of one or more physical properties of the hydrogen storage. In some aspects, the hydrogen storage 46a is not included within the electrolysis system 40.

The hydrogen output element 46b is configured to be coupled to a respective one or more of the product outlets 50 and convey the hydrogen generated by the electrolytic-cell stack 100 thereto. The hydrogen may be transferred continuously or in batches.

The oxygen output stream 48 is configured to convey oxygen generated by the electrolytic-cell stack 100 to a respective one or more of the product outlets 50. The oxygen output stream 48 may include, for example, an oxygen storage 48a and an oxygen output element 48b.

The oxygen storage 48a is configured to store and/or buffer the oxygen generated by the electrolytic-cell stack 100. The oxygen storage 48a may be, for example, an oxygen-storage vessel configured to store the oxygen under pressure. In some aspects, the oxygen storage 48a is not included within the electrolysis system 40.

The oxygen output element 48b is configured to be coupled to a respective one or more of the product outlets 50 and convey the oxygen generated by the electrolytic-cell stack 100 thereto. The oxygen may be transferred continuously or in batches.

The output stream may further include a plurality of optional components. For example, the output stream may include one or more byproducts output streams, one or more stream separation elements, one or more stream conditioning elements, and a recycle stream.

The byproducts output streams are configured to transfer one or more byproducts from the decomposition within the electrolytic-cell stack 100 to one or more of the outputs of the electrolysis environment 10.

The stream separation elements are configured to separate one portion of a received stream into one or more outputs. For example, the stream separation elements may be or include elements configured to separate hydrogen from water, oxygen from water, reactants from products, reactants from contaminants, combinations thereof, and the like.

The stream conditioning elements are configured to condition a respective stream to provide a desired composition or physical state. For example the stream conditioning elements may be configured to alter a temperature of the stream, a pressure of the stream, humidify a stream, dehumidify a stream, combinations thereof, and the like.

The recycle stream is configured to receive reactant material recovered by, for example, a stream separation element and to convey the reactant material to the fluid input stream 42.

FIG. 3 illustrates a partially exploded view of an electrolytic-cell stack 100, according to aspects of the present disclosure. The electrolytic-cell stack 100 includes one or more electrolytic cells 102. Each electrolytic cell 102 includes a membrane-electrode assembly 104 between a pair of polar plates 106.

The membrane-electrode assembly 104 includes an anode 108 and a cathode 110 that are electrically separated by a membrane layer 112. The anode 108 is configured to decompose a reactant into constituent components. For example, the anode 108 is configured to decompose water into molecular oxygen, protons, and electrons through the Oxygen Evolution Reaction. The anode 108 environment includes a high potential that will readily oxidize certain materials, such as carbon materials.

The cathode 110 is configured to evolve products by combining one or more of the decomposition products with supplied electrons. For example, the cathode 110 half-reaction may be the Hydrogen Evolution Reaction, which generates gaseous hydrogen by combining protons received from the membrane with an equal number of electrons.

The membrane layer 112 is configured to transport ions from the anode 108 to the cathode 110 while inhibiting transfer of electrons therethrough. The membrane layer 112 may be further configured to inhibit transfer of reactants, certain decomposition products, and/or decomposition byproducts therethrough. For example, the membrane layer 112 may allow for or promote proton transfer while inhibiting or preventing transfer of water and molecular oxygen therethrough. In some aspects, the membrane is a proton-exchange membrane configured to transfer protons therethrough. The proton-exchange membrane may be, for example, NAFION™.

The membrane-electrode assembly 104 may have a suitable design, such as a three-layer design, a five-layer design, a seven-layer design, and the like. While the designs illustrated and described below are symmetrical in both number of layers and size of each respective layer, it is contemplated that asymmetrical designs having a different number of layers, different layer thicknesses, and/or different layer sizing for the anode side and the cathode side.

In the three-layer design (alternatively referred to as a “catalyst-coated membrane”), both the anode 108 and the cathode 110 include a catalyst layer 114. The anode-side catalyst layer 114 includes anode-side catalyst particles 202 (e.g., iridium oxide particles 202 discussed further with reference to FIG. 4) configured to promote the decomposition reaction while resisting degradation under operating conditions of the electrolytic cell 102. For example, the anode-side catalyst particles 202 are configured to oxidize water while resisting oxidation in the high-potential environment of the anode 108 and to maintain structural integrity under the operating temperature of the anode 108. For example, anode-side catalyst particles 202 having lower activity for the oxygen evolution reaction may be favored over higher activity particles if they provide higher resistance to oxidation in the oxidizing environment. The anode-side catalyst layer 114 may be further configured to promote transfer of hydrated protons to the membrane. The anode-side catalyst particles 202 may be, for example, iridium oxide particles, iridium-containing particles, iridium-oxide-coated particles, and the like.

The anode-side catalyst layer 114 further includes corrosion-resistant, conductive nanoparticles 204 (discussed further with reference to FIG. 4) configured to enhance performance of the anode-side catalyst layer 114. For example, the corrosion-resistant, conductive nanoparticles 204 are configured to optimize interfacial contact and reduce in-plane discontinuity of the anode-side catalyst layer 114.

The anode-side catalyst particles 202 and the corrosion-resistant, conductive nanoparticles 204 are bound in a matrix. The matrix may be, for example, an ionomer.

The cathode-side catalyst layer 114 includes catalyst particles configured to promote the reduction of the protons into gaseous hydrogen. The cathode-side catalyst particles may be, for example, platinum particles, platinum-containing particles, platinum-coated particles, combinations thereof, and the like. The cathode-side catalyst particles are bound in a matrix by, for example, an ionomer.

In the five-layer design, the anode 108 and the cathode 110 include a catalyst layer 114 and a diffusion layer 116. Put differently, the five-layer design is the three-layer design with a diffusion layer 116 on each side of the catalyst-coated membrane.

The anode-side diffusion layer 116 may be, for example, a porous transport layer. The porous transport layer is configured to transport the reactant from the outer surface of the membrane-electrode assembly 104 to the anode-side catalyst layer 114 for reaction, to transport evolved molecular oxygen from the catalyst layer 114 to the outer surface of the membrane-electrode assembly 104, and to transport liberated electrons from the catalyst layer 114 to the outer surface of the membrane-electrode assembly 104. The porous transport layer is formed from a material that is porous, electrically conductive, resistant to oxidation in the high potential and oxygen-rich environment of the anode 108, and structurally robust at the stack compression and the operating temperatures of the electrolytic cell 102. The porous transport layer may be formed from, for example, titanium.

The cathode-side diffusion layer 116 may be, for example, a gas diffusion layer. The gas diffusion layer is configured to transport the evolved product (e.g., the gaseous hydrogen) from the cathode-side catalyst layer 114 to the outer surface of the membrane-electrode assembly 104, to transport supplied electrons from the outer surface of the membrane-electrode assembly 104 to the catalyst layer 114. The gas diffusion layer is formed from a material that is porous, electrically conductive, and structurally robust at the stack compression and the operating temperatures of the electrolytic cell 102. The gas diffusion layer may be formed from, for example, carbon fibers, carbon particles, carbon nanoparticles, binder materials, combinations thereof, and the like.

In the seven-layer design, the anode 108 and the cathode 110 include a catalyst layer 114 and diffusion media. Put differently, the seven-layer design is the three-layer design with a diffusion medium on each side of the catalyst-coated membrane. The diffusion media include at least a first layer and a second layer.

The first layer is disposed adjacent to the catalyst layer 114. The first layer is configured to enhance the performance of the catalyst layer 114. For example, the first layer may be configured to inhibit permeation of ionomer and/or catalyst particles from the catalyst layer 114 into the diffusion medium. In further examples, the first layer may be configured to inhibit excessive mass flowrate of the reactant to the catalyst layer 114. In yet further examples, the first layer may be configured to promote transfer of reaction side products or byproducts from the catalyst layer 114 to the diffusion medium. In still yet further examples, the first layer may promote electronic transfer between the catalyst layer 114 and the diffusion medium by increasing contact area with the catalyst particles above the contact area of the second layer alone. In some aspects, the first layer is a microporous layer.

The second layer is disposed on an outer surface of the membrane-electrode assembly 104. The second layer is configured to promote both mass transfer and electronic transfer between the catalyst layer 114 and the outer surface of the membrane-electrode assembly 104. For example, the second layer may be configured to promote mass transfer of water between the outer surface of the membrane-electrode assembly 104 and the catalyst layer 114. In further examples, the second layer may be configured to promote mass transfer of gaseous hydrogen or molecular oxygen from the catalyst layer 114 to the outer surface of the membrane-electrode assembly 104. In some aspects, the second layer is a diffusion layer 116, such as a gas diffusion layer or a porous transport layer.

In some aspects, the anode-side diffusion medium is a porous transport medium. The porous transport medium may include, for example a microporous layer as the first layer and a porous transport layer as the second layer.

The anode-side microporous layer may be configured to optimize functioning of the electrolytic cell 102 by, for example, increasing interfacial contact with the catalyst layer 114, preventing migration of ionomer or catalyst particles into the porous transport layer, optimizing interfacial contact resistance, and optimizing mass transfer by decreasing capillary pressure, combinations thereof, and the like. The microporous layer may be formed from a suitable material, such as a titanium material having a desired pore size and density.

The anode-side diffusion layer 116 may be, for example, a porous transport layer. The porous transport layer is configured to transport the reactant from the outer surface of the membrane-electrode assembly 104 to the anode-side catalyst layer 114 for reaction, to transport evolved molecular oxygen from the catalyst layer 114 to the outer surface of the membrane-electrode assembly 104, and to transport liberated electrons from the catalyst layer 114 to the outer surface of the membrane-electrode assembly 104. The porous transport layer is formed from a material that is porous, electrically conductive, resistant to oxidation in the high potential and oxygen-rich environment of the anode 108, and structurally robust at the stack compression and the operating temperatures of the electrolytic cell 102. The porous transport layer may be formed from, for example, titanium.

In some aspects, the cathode-side diffusion medium is a gas diffusion medium. The gas diffusion medium may include, for example a microporous layer as the first layer and a gas diffusion layer as the second layer.

The cathode-side microporous layer may be configured to optimize functioning of the electrolytic cell 102 by, for example, increasing interfacial contact with the catalyst layer 114, preventing migration of ionomer or catalyst particles into the porous transport layer, optimizing interfacial contact resistance, and enhancing hydrophilicity of the cathode-side diffusion media to thereby inhibit back-diffusion of hydrogen gas across the membrane. The cathode-side microporous layer may be formed from, for example, an electrically conductive material and a polymeric binder material. The electrically conductive material may be, for example, electrically conductive particles formed from one or more carbon materials. The polymeric material may be or include, for example, a hydrophilic or hydrophobic polymer. In some aspects, the polymeric binder material is a polymer matrix that suspends the electrically conductive particles with a loading amount that is sufficient to provide a desired electrical conductivity.

The cathode-side diffusion layer 116 may be, for example, a gas diffusion layer. The gas diffusion layer is configured to transport the evolved product (e.g., the gaseous hydrogen) from the cathode-side catalyst layer 114 to the outer surface of the membrane-electrode assembly 104, to transport supplied electrons from the outer surface of the membrane-electrode assembly 104 to the catalyst layer 114. The gas diffusion layer is formed from a material that is porous, electrically conductive, and structurally robust at the stack compression and the operating temperatures of the electrolytic cell 102. The gas diffusion layer may be formed from, for example, for example, carbon fibers, carbon particles, carbon nanoparticles, binder materials, combinations thereof, and the like.

The polar plates 106 are configured to transfer electrical charge from an adjacent cathode 110 or anode 108. The polar plates 106 include a flow field on each side of the polar plate 106 that is configured to transmit a fluid thereacross. The fluid in each flow field may be, for example, one or more reactants, one or more products, or a coolant. The polar plates 106 may have a low electrical resistance, a high mechanical stability, and a high chemical stability. The polar plates 106 may also have high thermal conductivity.

Each of the anode-side polar plates 106 is electrically coupled to at least one other of the anode-side polar plates 106, and each of the cathode-side polar plates 106 is electrically coupled to at least one other of the cathode-side polar plates 106. The anode-side polar plates 106 are electrically isolated from the cathode-side polar plates 106. Each polar plate 106 is disposed adjacent to at least one electrolytic cell 102 and may be a monopolar plate or a bipolar plate.

Each monopolar plate is disposed adjacent to a single electrolytic cell 102 and includes a first face opposite a second face. The first face of the monopolar plate includes, for example a flow field for one or more reactants or one or more products. Whether the flow field conveys the reactants or the products will depend on whether the monopolar plate is adjacent to an anode 108 or to a cathode 110. The second face of the monopolar plate may include a flow field configured to convey a coolant therethrough.

Each of the bipolar plate is disposed between a pair of electrolytic cells 102. The bipolar plates will be adjacent to the anodes 108 or the cathodes 110 of the pair of electrolytic cells 102. Each bipolar plate includes a first face opposite a second face and a body therebetween. Both the first face and the second face of the bipolar plates include a flow field to convey one or more reactants or one or more products. Whether the flow field conveys the reactants or the products will depend on whether the monopolar plate is adjacent to an anode 108 or to a cathode 110. The body may include a flow field configured to convey a coolant therethrough. The bipolar plates may be formed by, for example, placing two monopolar plates back-to-back and bonding them together.

The electrolytic cells 102 further include a gasket 120 disposed, for example, around one or more of the catalyst layer 114, the diffusion layer 116, and the diffusion medium. The gasket 120 is configured to reduce and/or balance the compressive force applied to the active portions of the membrane-electrode assembly 104. The gasket 120 is further configured to provide a fluid-tight seal between the plate and membrane layer 112.

The electrolytic-cell stack 100 further includes end plates 118. The endplates 118 are disposed at the top and bottom of the electrolytic-cell stack 100. The endplates 118 include a plurality of port sets. Each port set includes an inlet port and an outlet port. Each port set is fluidly coupled with one or more channels of the flow fields within the electrolytic-cell stack 100 to form a fluid circuit. For example, the fluid circuit may convey the respective fluid from the inlet port to an entrance of the flow field through, for example, a first set of via holes in the plates and the gaskets 120. The respective fluid may then be conveyed across the respective flow fields to an exit of the flow field. After exiting the flow field, the respective fluid may be conveyed to the outlet port through, for example, a second set of via holes in the plates and gaskets 120. As used herein, “fluids” can refer to reactants, products, coolants, or any combination thereof as the context dictates. For example, “fluid inlets” can refer to any or all of reactant inlets, oxidant inlets, or coolant inlets as the context dictates, and “product channels,” can refer to channels conveying a desired product and/or byproduct as context dictates. It is contemplated that one or more port sets may include the fluid inlet or the fluid outlet on one endplate 118 with the remaining fluid outlet or fluid inlet being located on the opposite endplate 118 such that the respective fluid circuit traverses the electrolytic-cell stack 100 longitudinally.

The endplates 118 are further configured to engage a compressive member that is configured to apply a compressive force to the electrolytic-cell stack 100 along the stacking direction. The compressive force is configured to the components of the electrolytic-cell stack 100 in position through a contact pressure between adjacent components. In some aspects, the compressive member includes a plurality of threaded rods that engage structures on the endplates 118. The threaded rods may be tightened to increase the compressive force to a desired level along the stacking direction, which results in a contact pressure being distributed along the interfaces between longitudinally adjacent components.

FIG. 4 is a lateral end view of the anode 108 of the membrane-electrode assembly 104, including the membrane layer 112, the anode-side catalyst layer 114, and the porous transport layer. The anode-side catalyst layer 114 is formed from a mixture of anode-side catalyst particles 202 and corrosion-resistant, conductive nanoparticles 204 within a binder (not shown).

The anode-side catalyst particles 202 are configured to promote the decomposition reaction while resisting degradation under high potential and high temperature conditions of the electrolytic cell 102. For example, the anode-side catalyst particles 202 are configured to oxidize water while resisting oxidation in the high-potential environment of the anode 108 and to maintain structural integrity under the high-temperature environment that occurs in the anode 108. In the illustrated embodiment, the anode-side catalyst particles 202 are formed from iridium oxide (IrOₓ). It is contemplated that the anode-side catalyst particles 202 may include other materials or may be a support particle that is coated with iridium oxide.

The anode-side catalyst particles 202 have a high surface area to optimize contact with the reactants at reduced loading values. For example, the anode-side catalyst particles 202 may achieve the high surface area using porous structures. The surface area may be, for example, from about 20 m²/g to about 300 m²/g as measured by the Brunauer-Emmett-Teller (“BET”) method.

In some aspects, the anode-side catalyst particles 202 may have an average diameter, D50 , from about 2 nanometers to about 250 nanometers. More particularly, the anode-side catalyst particles 202 may a have an average diameter from about 10 nanometers to about 50 nanometers. The catalyst particles 202 may be selected to provide a desired unmixed packing density. The unmixed packing density may be measured by forming a coating without any corrosion-resistant, conductive nanoparticles 204. In some aspects, the unmixed packing density of the anode-side catalyst particles 202 is from about 1 gram per cubic centimeter to about 3 grams per cubic centimeter. More desirably, the unmixed packing density of the anode-side catalyst particles 202 is from about 1.2 grams per cubic centimeter to about 2.5 grams per cubic centimeter. As would be recognized by one of ordinary skill in the art, the packing density of the catalyst particles 202 in the mixed catalyst layer 114 will be lower than the unmixed packing density of the catalyst particles 202.

The corrosion-resistant, conductive nanoparticles 204 are configured to optimize performance of the electrolytic cells 102 at reduced catalyst loadings. The corrosion-resistant, conductive nanoparticles 204 also have a lower packing density than the anode-side catalyst particles 202. The corrosion-resistant, conductive nanoparticles 204 may be sized and/or shaped to provide a desired unmixed packing density. The unmixed packing density may be measured by forming a coating without any anode-side catalyst particles 202. In some aspects, the unmixed packing density of the corrosion-resistant, conductive nanoparticles 204 is from about 0.5 grams per cubic centimeter to about 2.5 grams per cubic centimeter. More desirably, the unmixed packing density of the corrosion-resistant, conductive nanoparticles 204 is from about 1 grams per cubic centimeter to about 2 grams per cubic centimeter. As would be recognized by one of ordinary skill in the art, the packing density of the corrosion-resistant, conductive nanoparticles 204 in the mixed catalyst layer 114 will be lower than the unmixed packing density of the corrosion-resistant, conductive nanoparticles 204.

Beneficially, the corrosion-resistant, conductive nanoparticles 204 inhibit voltage losses at reduced iridium loadings by providing electrically conductive bridges between anode-side catalyst particles 202 that would otherwise be disconnected from each other. Moreover, the corrosion-resistant, conductive nanoparticles 204 may also dilute the anode-side catalyst particles 202, which produces a thicker catalyst layer 114 with the same catalyst loading amount. The thicker catalyst layer 114 with optimized thickness reduces contact resistance and increases interfacial contact between the layers.

The optimized thickness of the catalyst layer 114 is dependent on surface features of the layer abutting the catalyst layer 114. For example, if the abutting layer has a coarse surface such as a porous transport layer, then the catalyst layer may have an optimized thickness of at least about 4 microns. In further examples, if the abutting layer has a smooth surface such as a microporous layer of a porous transport medium, then the catalyst layer may have an optimized thickness of at least about 2 microns.

The corrosion-resistant, conductive nanoparticles 204 may be include one or more suitable materials such that the corrosion-resistant, conductive nanoparticles 204 are resistant to corrosion in the high potential and oxygen-rich conditions of the anode 108, withstand in the operating temperatures of the anode 108, and may withstand the compression of the electrolytic-cell stack 100.

The corrosion-resistant, conductive nanoparticles 204 may be a uniform material or may be a coated particle. Coated corrosion-resistant, conductive nanoparticles 204 include a support and a coating. The support is configured to provide a structure and compatible surface to receive the coating thereon and to withstand the temperature of the anode 108. Beneficially, the support provides a space-filling replacement for more valuable elements and compounds without reduced effectiveness of the corrosion-resistant, conductive nanoparticles 204. The support may be formed from, for example, titanium oxides (e.g., TiO₂, Ti₄O₇), niobium oxides (e.g., Nb₂O₅), zirconium oxides (e.g., ZrO₂), tantalum oxides (e.g., Ta₂O₅), combinations thereof, and the like.

The coating is configured to withstand the high potential and oxygen-rich environment of the anode 108. The coating may be, for example, iridium, platinum, precious metals, oxides thereof, combinations thereof, and the like. More specifically, the coating may be selected from the group consisting of iridium, platinum, and gold.

The coating is applied to the support in an amount sufficient to protect the support from the environment. In some aspects, the coating is a continuous layer to form a core-shell structure. In certain embodiments, the coating is discontinuous and is applied in an amount sufficient to achieve the desired conductivity across the corrosion-resistant, conductive nanoparticle 204 and through the catalyst layer 114. In some aspects, the coating is platinum in an amount to provide from about 40% by weight to about 80% by weight on the basis of the weight of the particle.

In some aspects, the corrosion-resistant, conductive nanoparticles 204 may be formed from one or more of titanium oxides (e.g., TiO₂, Ti₄O₇), iridium-coated oxides, precious-metal oxides, precious-metal-coated oxides, combinations thereof, and the like. The iridium-coated oxides may be, for example, iridium-coated titanium oxide (e.g., Ir/TiO₂), iridium-coated niobium oxide (e.g., Ir/Nb₂O₅), iridium-coated zirconium oxide (e.g., Ir/ZrO₂), iridium-coated tantalum oxide (e.g., Ir/Ta₂O₅), combinations thereof, and the like.

The precious-metal oxide particles may be, for example, gold oxide and platinum oxide. The precious-metal-coated oxides may be, for example, platinum-coated oxides, and gold-coated oxides. The platinum-coated oxides may be, for example, platinum-coated titanium oxide (e.g., Pt/TiO₂), platinum-coated niobium oxide (e.g., Pt/Nb₂O₅), platinum-coated zirconium oxide (e.g., Pt/ZrO₂), platinum-coated tantalum oxide (e.g., Pt/Ta₂O₅), combinations thereof, and the like. The gold-coated oxides may be, for example, gold-coated titanium oxide (e.g., Au/TiO₂), gold-coated niobium oxide (e.g., Au/Nb₂O₅), gold-coated zirconium oxide (e.g., Au/ZrO₂), gold-coated tantalum oxide (e.g., Au/Ta₂O₅), combinations thereof, and the like.

Preferably, the corrosion-resistant, conductive nanoparticles 204 are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅). In further preferable examples, corrosion-resistant, conductive nanoparticles 204 are selected from the group consisting of platinum-coated titanium dioxide (Pt/TiO₂), gold-coated titanium dioxide (Au/TiO₂), and iridium-coated titanium dioxide (Ir/TiO₂). More preferably, the corrosion-resistant, conductive nanoparticles 204 are platinum-coated titanium dioxide (Pt/TiO₂). In alternative more preferable aspects, the corrosion-resistant, conductive nanoparticles 204 are iridium-coated titanium oxide (Ir/TiO₂). While not explicitly labeled, the coating of the iridium-coated titanium oxide may be partially or fully oxidized prior to incorporation in the catalyst layer 114.

The corrosion-resistant, conductive nanoparticles 204 may have a particle size from about 2 nanometers to about 300 nanometers. The average particle size, given as a D50 basis, is from 10 nanometers to 150 nanometers. Beneficially, sizes in this range enhance electrical continuity between anode-side catalyst particles 202 and enhance contact between the catalyst layer 114 and adjacent layers (such as the porous transport layer).

The binder is configured to form a matrix that maintains a distribution of the particles in the catalyst layer 114. The binder may be, for example, an ionomer configured to provide ion transport to and/or from the anode-side catalyst particles 202.

The catalyst layer 114 includes a desired loading ratio of the iridium oxide anode-side catalyst particles 202 and the corrosion-resistant, conductive nanoparticles 204. In some aspects, the weight-to-weight ratio of corrosion-resistant, conductive nanoparticles 204 to iridium oxide particles 202 is from about 0.5:1 to about 8:1. The desired iridium oxide loading and the desired layer thickness may be selected prior to selecting the weight-to-weight ratio of iridium oxide to corrosion-resistant, conductive nanoparticles 204. For example, if the abutting layer has a coarse surface (e.g., a porous transport layer) and the desired areal loading of iridium oxide is at about 0.1 milligrams per square centimeter, the weight-to-weight ratio of corrosion-resistant, conductive nanoparticles 204 to iridium oxide particles 202 is a selected value from about 0.5:1 to about 8:1 such that the resulting catalyst layer has an optimized thickness of 4 microns. In further examples, if the abutting layer has a smooth surface (e.g., a microporous layer of a porous transport medium), and the desired areal loading of iridium oxide is at about 0.1 milligrams per square centimeter, the weight-to-weight ratio of corrosion-resistant, conductive nanoparticles 204 to iridium oxide particles 202 is a selected value from about 0.5:1 to about 8:1 such that the resulting catalyst layer has an optimized thickness of 2 microns. As can be seen, if the desired thickness of the resulting catalyst layer is greater, then the selected weight-to-weight ratio of corrosion-resistant, conductive nanoparticles 204 to iridium oxide particles 202 may be increased to provide a resulting catalyst layer 114 with a greater thickness at the same areal loading of iridium oxide. Similarly, if a lower areal loading of iridium oxide is desired, the selected weight-to-weight ratio of corrosion-resistant, conductive nanoparticles 204 to iridium oxide particles 202 may be increased to provide a catalyst layer 114 with an identical thickness.

Specifically, if the mixed oxide catalyst layer 114 has a thickness of 2 microns and an iridium oxide areal loading of 0.1 milligrams per square centimeter, the selected weight-to-weight ratio of corrosion-resistant, conductive nanoparticles 204 to iridium oxide particles 202 is 3:1 to provide and an iridium oxide packing density of 0.5 grams per cubic centimeter. Similarly, if the mixed oxide catalyst layer 114 has a thickness of 4 microns and an iridium oxide areal loading of 0.1 milligrams per square centimeter, the selected weight-to-weight ratio of corrosion-resistant, conductive nanoparticles 204 to iridium oxide particles 202 is 7:1 to provide and an iridium oxide packing density of 0.25 grams per cubic centimeter.

FIG. 5 is a lateral end view of an anode 308 of an example membrane-electrode assembly, including the membrane layer 112, an anode-side catalyst layer 314, and the porous transport layer. The anode-side catalyst layer 314 is formed from the same quantity and amount of anode-side catalyst particles 202 as the membrane-electrode assembly 104.

As can be seen, despite the same loading weight of anode-side catalyst particles 202, the anode-side catalyst layer 314 is thinner than the anode-side catalyst layer 114 of the electrolytic-cell stack 100. Further, as can be seen, despite the same loading weight of anode-side catalyst particles 202, there is a significant electrical discontinuity between the anode-side catalyst particles 202. This discontinuity increases voltage loss of the anode 308.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover all modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “substantially” are readily understood by one of ordinary skill in the art, the term “substantially” indicates that the stated numerical value or property allows some imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., ±5%) of the stated value.

While the metes and bounds of the term “essentially” are readily understood by one of ordinary skill in the art, the term “essentially” indicates that the stated numerical value or property allows some slight imprecision. If the imprecision provided by “essentially” is not otherwise understood in the art with this ordinary meaning, then “essentially” indicates at least negligible variations in desired parameters that may be impracticable to overcome. For example, if not otherwise understood in the art, the term “essentially” means within 1% (e.g., ±1%) of the stated value.

While the metes and bounds of the term “pure” are readily understood by one of ordinary skill in the art, the term “pure” indicates that the compound may include very slight traces of other materials. If the imprecision provided by “pure” is not otherwise understood in the art with this ordinary meaning, then “pure” indicates at least variations that may arise from separation processes and measurement of such parameters. For example, if not otherwise understood in the art, the term “pure” means above 99.9% of the stated material.

It is to be understood that the ranges provided herein include the stated range, subranges within the stated range, and each value within the stated range. For example, a range from 5% to 20% should be interpreted to include not only the explicitly recited limits of about 5% to about 20%, but also to include individual values, such as 5%, 7%, 9%, 13%, etc., and sub-ranges, such as from about 5% to about 9%, about 7% to about 10%, etc.

While the best modes for carrying out the disclosure have been described in detail, those familiar with the art to which this disclosure relates will recognize various alternative designs and embodiments for practicing the disclosure within the scope of the appended claims.

1. A catalyst layer comprising:
a homogenous mixture of:
catalyst particles configured to promote water electrolysis, the catalyst particles including iridium and having a high surface area; and
corrosion-resistant, conductive nanoparticles configured to resist oxidation, to reduce packing discontinuities of the catalyst particles, and to provide an electrically conductive bridge between the catalyst particles; and
a matrix configured to support the catalyst particles and the corrosion-resistant, conductive nanoparticles.

2. The catalyst layer of claim 1, wherein the catalyst particles are selected from the group consisting of iridium oxide particles or iridium-oxide containing particles.

3. The catalyst layer of claim 1, wherein the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

4. The catalyst layer of claim 1, wherein the corrosion-resistant, conductive nanoparticles are selected from the group consisting of platinum-coated titanium dioxide (Pt/TiO₂), gold-coated titanium dioxide (Au/TiO₂), and iridium-coated titanium dioxide (Ir/TiO₂).

5. The catalyst layer of claim 1, wherein the corrosion-resistant, conductive nanoparticles are platinum-coated particles with a platinum content of 40% by weight to 80% by weight on a basis of the weight of the corrosion-resistant, conductive nanoparticle.

6. The catalyst layer of claim 1, wherein the corrosion-resistant, conductive nanoparticles have an average size from 20 nanometers to 300 nanometers.

7. The catalyst layer of claim 1, wherein the ratio of corrosion-resistant, conductive nanoparticles to catalyst particles is from 0.5:1 to 8:1 on a basis of weight.

8. The catalyst layer of claim 1, wherein the catalyst layer has a thickness greater than 4 microns and an iridium oxide packing density of less than 0.25 milligrams per cubic centimeter.

9. The catalyst layer of claim 1, wherein the catalyst layer has a thickness greater than 2 microns and an iridium oxide packing density of less than 0.5 milligrams per cubic centimeter.

10. A membrane-electrode assembly comprising:
an anode having a catalyst layer including:
a homogenous mixture of:
catalyst particles configured to promote water electrolysis, the catalyst particles including iridium and having a high surface area; and
corrosion-resistant, conductive nanoparticles configured to resist oxidation, to reduce packing discontinuities of the catalyst particles, and to provide an electrically conductive bridge between
the catalyst particles; and
a matrix configured to support the catalyst particles and the corrosion-resistant, conductive nanoparticles;
a cathode; and
a membrane disposed between the anode and the cathode.

11. The membrane-electrode assembly of claim 10, wherein the catalyst particles are selected from the group consisting of iridium oxide particles or iridium-oxide containing particles.

12. The membrane-electrode assembly of claim 10, wherein the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

13. The membrane-electrode assembly of claim 10, wherein the corrosion-resistant, conductive nanoparticles are platinum-coated particles with a platinum content of 50% by weight to 80% by weight on a basis of the weight of the corrosion-resistant, conductive nanoparticle.

14. The membrane-electrode assembly of claim 10, wherein the corrosion-resistant, conductive nanoparticles have an average size from 20 nanometers to 300 nanometers.

15. The membrane-electrode assembly of claim 10, wherein the ratio of corrosion-resistant, conductive nanoparticles to catalyst particles is from 0.5:1 to 8:1 on a basis of weight.

16. The membrane-electrode assembly of claim 10, wherein the catalyst layer has a thickness greater than 4 microns and an iridium oxide packing density of less than 0.25 milligrams per cubic centimeter.

17. An electrolytic cell comprising:
a membrane-electrode assembly including a membrane disposed between an anode and a cathode, the anode having a catalyst layer including:
a homogenous mixture of:
catalyst particles configured to promote water electrolysis, the catalyst particles including iridium and having a high surface area; and
corrosion-resistant, conductive nanoparticles configured to resist oxidation, to reduce packing discontinuities of the catalyst particles, and to provide an electrically conductive bridge between the catalyst particles; and
a matrix configured to support the catalyst particles and the corrosion-resistant, conductive nanoparticles; and
a pair of polar plates abutting opposite sides of the membrane-electrode assembly, each of the pair of polar plates being electrically coupled to a respective one of the anode and the cathode and being fluidically coupled to the respective one of the anode and the cathode.

18. The electrolytic cell of claim 17, wherein the corrosion-resistant, conductive nanoparticles are selected from the group consisting of Magnéli-phase titanium oxide (Ti₄O₇), platinum-coated titanium dioxide (Pt/TiO₂), platinum-coated niobium oxide (Pt/Nb₂O₅), platinum-coated zirconium oxide (Pt/ZrO₂), and platinum-coated tantalum oxide (Pt/Ta₂O₅).

19. The electrolytic cell of claim 17, wherein the corrosion-resistant, conductive nanoparticles are platinum-coated particles with a platinum content of 40% by weight to 80% by weight on a basis of the weight of the corrosion-resistant, conductive nanoparticle.

20. The electrolytic cell of claim 17, wherein the wherein the ratio of corrosion-resistant, conductive nanoparticles to catalyst particles is from 0.5:1 to 8:1 on a basis of weight.
